(19) United States
(12) Patent Application Publication
(10) Pub. No.: US 2004/0012323 A1
(43) Pub. Date: Jan. 22, 2004

(54) Deflection yoke with vertical deflection coil fixing structure

(76) Inventors: Hwan-Seok Choe, Suwon-si (KR); Sung-Woon Kim, Anyang-si (KR)

Correspondence Address: GOTTLIEB RACKMAN & REISMAN PC, 270 MADISON AVENUE, 8TH FLOOR, NEW YORK, NY, 100160601

(21) Appl. No.: 10/612,639

(22) Filed: Jul. 1, 2003

(30) Foreign Application Priority Data
Jul. 22, 2002 (KR) 2002-43002
Jun. 10, 2003 (KR) 2003-37122

(51) Int. Cl. H01J 29/70

(52) U.S. Cl. 313/440

(57) ABSTRACT

A deflection yoke includes a coil separator having a screen portion, a neck portion, and a connection portion, and having at least one protrusion formed on at least one of the screen portion and the neck portion, a horizontal deflection coil disposed on an inside of the coil separator to generate a horizontal magnetic field, a vertical deflection disposed on an outside of the coil separator to generate a vertical magnetic field, and having a pin hole formed on a position corresponding to the at least one protrusion coupling the vertical deflection coil to the coil separator.

### CROSS-REFERENCE TO RELATED APPLICATION

This application claims to benefit of Korean Patent Application No. 2002-43002, filed Month day, 2002 and Korean Patent Application No. 2003-37122, filed Month day, 2003, in the Korean Intellectual Property Office, the disclosure of which is incorporated herein by reference.

### BACKGROUND OF THE INVENTION

1. Field of the Invention

The present invention relates to a deflection yoke mounted on a CRT of a computer monitor or a TV monitor, and more particularly, to a deflection yoke having a hook-type protrusion formed on a coil separator to easily assemble a vertical deflection coil to the coil separator, thereby removing a hot-melt applying process to improve an assembling and manufacturing efficiency, the deflection yoke having an assembling protrusion formed on the coil separator to be inserted into an assembling groove formed on each of divided surfaces of a ferrite core to provide an assembling reliability of the vertical deflection coil.

2. Description of the Related Art

Generally, a cathode ray tube (CRT) includes a panel having a fluorescence layer emitting three colors, and a funnel coupled to edge portions of the panel.

An electron gun is mounted on a neck portion of the funnel to scan an electron beam, and a deflection yoke is mounted on a circumference of the funnel to deflect the electron beam emitted from the electron gun corresponding to red, green, and blue colors.

A shadow mask is mounted on a frame of the CRT by welding and includes a plurality of holes, through which the electron beam passes, spaced-apart from the fluorescence layer of the panel.

A stud pin is mounted on an inside surface of the panel to support the frame, and an inner shield is mounted on a side portion of the frame to control and shield a trajectory of the electron beam emitted from the electron gun.

A deflection principle of the electron beam emitted from the electron gun is adopted in the conventional CRT, and magnetic fields are applied to the neck portion of the CRT in horizontal and vertical directions to scan the electron beam.

Coils, which form the magnetic fields in the horizontal and vertical directions, are called horizontal and vertical deflection coils (horizontal deflection sub-coils and vertical deflection sub-coils) which are assembled to form the horizontal and vertical magnetic fields perpendicular to each other. The horizontal and vertical deflection coils and the ferrite core constitute the deflection yoke.

Generally, the deflection yoke is mounted on the CRT of the TV or computer monitor to precisely land the deflected electron beam on the fluorescence layer coated on a screen of the CRT by precisely deflecting the electron beam corresponding to the red, green, and blue colors.

The deflection yoke is classified into a coil separator according to a type of the CRT and is also classified into one of saddle-toroidal and saddle-saddle types according to a shape of a coil. The saddle-toroidal type deflection yoke is used in the TV monitor, and the saddle-saddle type deflection yoke is used in the computer monitor.

FIG. 1 is a cross-sectional view showing a general saddle-saddle type deflection yoke used in the computer monitor. The general saddle-saddle type deflection yoke includes a coil separator 1, a horizontal deflection coil (H-coil) 2 and a vertical deflection coil (V-coil) 3 disposed in an inside and an outside of the coil separator 1 to deflect an electron beam emitted from an electron gun in a horizontal direction and in a vertical direction, respectively, and a ferrite core 4 surrounding a circumference of the vertical deflection coil (3).

The coil separator 1 insulates the horizontal deflection coil 2 and the vertical deflection coil 3 and is precisely assembled with the horizontal deflection coil 2 and the vertical deflection coil 3 of which positions are adjusted with respected to the coil separator 1 during an assembling process. The horizontal deflection coil 2 and the vertical deflection coil 3 are supplied with current to generate the horizontal and vertical magnetic fields, respectively, and the ferrite core 4 strengthens the vertical magnetic field generated from the vertical deflection coil 3. The horizontal deflection coil 2 is formed of a plurality of horizontal deflection sub-coils, and the vertical deflection coil 3 is formed of a plurality of vertical deflection sub-coils. Also, the ferrite core is formed of a plurality of ferrite sub-cores.

The deflection yoke controls the electron beam corresponding to the red (R), green (G), blue (B) colors and emitted from the electron gun of the CRT according to a saw pulse supplied to the horizontal and vertical deflection coils 2 and 3 using the Fleming's left hand rule, thereby deflecting the electron beam to be scanned on the screen.

In this structure of the deflection yoke, the coil separator 1 includes a screen portion 1a formed on a first end of the coil separator 1 and having a large diameter, a neck portion 1b formed on a second end of the coil separator 1 and having a small diameter, and a connection portion 1c having a trumpet shape and connecting the screen portion 1a and the neck portion 1b.

The coil separator 1 is assembled with the vertical deflection coil 3 having a saddle shape coupled to a circumference of the connection portion 1c. The vertical deflection coil 3 is formed of a pair of winding coils having the same saddle shape as the coil separator 1. The pair of the winding coils are disposed opposite to each other with respect to the coil separator 1 and closely attached to the coil separator 1.

The deflection yoke having the above structure generates the magnetic fields to deflect the electron beam emitted from the electron gun when a voltage is selectively supplied to the horizontal and vertical deflection coils 2 and 3.

According to a mounted position and a winding coil shape of the horizontal and vertical deflection coils 2 and 3 mounted on an inside surface and an outside surface of the coil separator 1, respectively, a deflection angle is deviated from a desired angle, and a normal image cannot be realized due to a reverse-cross and a miss-convergence caused by the deviated deflection angle.

If the vertical deflection coil 3 is not precisely disposed along a longitudinal direction (axial direction) of the deflection yoke when being assembled with the coil separator 1, left and right portions of the magnetic field become different from each other, this difference between the left and right portions of the magnetic field causes the miss-convergence and geometric distortion (G/D).

In order to overcome these problems, the vertical deflection coil 3 needs to be closely precisely attached to a circumference of the coil separator 1.

However, when the vertical deflection coil 3 of the saddle-saddle type is assembled with the coil separator 1, the vertical deflection coil 3 is closely disposed on the coil separator 1 and attached to the coil separator using a tape (T) as shown on FIG. 2A since any coupling member is not formed on the coil separator 1 to couple the vertical deflection coil 3 to the coil separator 1. As shown in FIG. 2B, after the ferrite core 4 is disposed to cover an outside of the vertical deflection coil 3, and the ferrite sub\-cores are coupled to each other by locking members. The vertical deflection sub-coils of the vertical deflection coil 3 are united using an adhesive of a hot-melt material, thereby fixing the vertical deflection coil 3 on the coil separator 1 as shown in FIG. 2C.

Since the vertical deflection sub-coils of the vertical deflection coil 3 are attached to opposite portions of the coil separator 1 in opposite directions with respect to the coil separator 1 and may have different adhering forces to be attached to the coil separator 1, the vertical deflection sub-coils are minutely moved when the ferrite sub-cores of the ferrite core 4 are disposed to cover the vertical deflection sub-coils of the vertical deflection coil 3.

Here, the minutely moved vertical deflection sub-coils of the vertical deflection coil 3 become deviated from original positions on the coil separator 1. According to a movement of the vertical deflection coil 3 with respect to the coil separator 1, a formation position of the vertical deflection magnetic fields generated from the vertical deflection coil 3 is changed, thereby causing problems of enlarging an image dispersion in the CRT.

Moreover, since a method of attaching (fixing) the vertical deflection coil 3 to the coil separator 1 as described above is a method of merely applying the adhesive, such as a bonding material, to the vertical deflection coil 3, the vertical deflection sub-coils of the vertical deflection coil 3 cannot be precisely attached to the coil separator 1 at the original positions. Even after being mounted on the coil separator 1, the vertical deflection sub-coils of the vertical deflection coil 3 are moved from the original positions to other positions of the coil separator 1 due to an external shock and a shaking force, and the movement of the vertical deflection coil 3 causes a position of the vertical deflection sub-coils of the vertical deflection coil 3 with respect to the coil separator 1 to be changed. Therefore, it is an disadvantage that inconsistency of the convergence and distortion of a pin cushion are generated.

That is, a poor fixed-state of the vertical deflection coil 3 cause a mis-landing of the electron beam emitted from the electron gun, thereby reducing a picture quality of an TV image.

In addition, the fixing method of fixing the vertical deflection coil 3 on the coil separator 1 increases a manufacturing time since a user holds the vertical deflection coil 3 with a user hand to attach the tape T to the vertical deflection coil 3 and applies the adhesive to the vertical deflection coil 3 to attach the vertical deflection coil 3 to the coil separator 1.

Furthermore, a dispersion is generated depending on a user skillfulness in the method of attaching the vertical deflection coil 3 to the coil separator using the tape T or the adhesive and the bonding material.

That is, according to user workability or skillfulness, the vertical deflection coil 3 is not precisely attached to the coil separator 1. Even if the vertical deflection coil 2 is attached to the coil separator 1, fixing state and position of the vertical deflection coil 3 on the coil separator 1 may be changed.

As described above, if the vertical deflection coil 3 is not precisely attached to the coil separator 1, a performance of the deflection yoke deteriorates, thereby causing a bad effect on the CRT.

Since the hot melt material is applied to the vertical deflection coil 3 while the vertical deflection coil 3 is disposed on the coil separator 1 using the tape T, assembling and manufacturing efficiencies of the deflection yoke are reduced.

Since the poor fixed-state of the vertical deflection coil 3 causes the mis-landing of the electron beam emitted from the electron gun, the picture quality of the TV image deteriorates.

Also, a bad smell is generated from the hot melt material during applying the hot melt material to the vertical deflection coil 3 and causes a bad effect on the user health, and the user feels a discomfort from the bad smell, thereby causing a poor working environment.

### SUMMARY OF THE INVENTION

In order to solve the above and/or other problems, it is an aspect of the present invention to provide a deflection yoke to reduce a manufacturing cost by removing a tape attaching process and a hot melt applying process and to improve assembling and manufacturing efficiencies by reducing the number of items provided in an assembling process of a vertical deflection coil during assembling the vertical deflection coil to a coil separator.

According another aspect of the present invention is to provide a deflection yoke to prevent a vertical deflection coil from moving minutely with respect to a coil separator during an assembling process of the vertical deflection coil with the coil separator and to reduce a picture dispersion of an image on a CRT.

According to another aspect of the present invention is to provide a deflection yoke to improve a working environment by preventing a bad smell occurring during a conventional hot melt applying process from being generated.

Additional aspects and advantages of the invention will be set forth in part in the description which follows and, in part, will be obvious from the description, or may be learned by practice of the invention.

To achieve the above and/or other aspects, a deflection yoke includes a coil separator having a screen portion, a neck portion, and a connection portion coupled between the screen portion and the neck portion, and having at least one protrusion formed on at least one of the screen portion and the neck portion, a horizontal deflection coil disposed on an inside of the coil separator to generate a horizontal magnetic field, a vertical deflection disposed on an outside of the coil separator to generate a vertical magnetic field, and having a pin hole formed on a position corresponding to the at least one protrusion to couple the vertical deflection coil to the coil separator, and a ferrite core disposed on the vertical deflection coil to strengthen the vertical magnetic field.

According to another aspect of the present invention, the vertical deflection coil includes a screen bent portion, the coil separator includes a support formed on the screen portion to support the screen bent portion, and the at least one protrusion of the coil separator is coupled to an upper portion of the screen bent portion of the coil separator to couple the vertical deflection coil to the coil separator.

According to another aspect of the present invention, the at least one protrusion includes an inclined surface inclined with respect to a direction in which the vertical deflection coil is mounted on the coil separator, and a coupling surface preventing the vertical deflection from being released from the coil separator.

According to another aspect of the present invention, the at least one protrusion includes first and second sub-protrusions formed on the screen portion and the neck portion of the coil separator, respectively, and the pin hole includes first and second pin sub-holes formed on the coil separator at positions corresponding to the first and second sub-protrusions.

According to another aspect of the present invention, the coil separator includes first and second supports formed on the screen portion and the neck portion of the coil separator, respectively, and the first and second sub-protrusions are formed on a lower surface of the first support and an upper surface of the second support, respectively.

According to another aspect of the present invention, the coil separator includes an assembling projection, and the ferrite core includes an assembling groove formed on a position corresponding to the assembling projection of the coil separator to securely attach the ferrite core to the coil separator using the assembling projection.

According to another aspect of the present invention, a display device having a deflection yoke includes a coil separator having a screen portion, a neck portion, and a connection portion coupled between the screen portion and the neck portion, having first supports formed on the screen portion and first protrusions, and having second supports formed on the screen portion and second protrusions. The display device further includes a plurality of vertical deflection sub-coils disposed on an outside of the coil separator to generate a vertical magnetic field, having a screen bent portion and a neck bent portion, and having first pin holes formed on the screen bent portion to receive corresponding ones of the first protrusions of the coil separators, and second pin holes formed on the neck bent portion to receive corresponding ones of the second protrusions.

### BRIEF DESCRIPTION OF THE DRAWINGS

These and other advantages of the invention will become apparent and more readily appreciated from the following description of the preferred embodiments, taken in conjunction with the accompanying drawings of which:

FIG. 1 is a cross-sectional view of a conventional saddle-saddle type deflection yoke;

FIGS. 2A-2C are front views of a structure for fixing a vertical deflection coil on a coil separator of the deflection yoke shown in FIG. 1;

FIG. 3 is a view showing a vertical deflection coil fixing structure of a deflection yoke according to an embodiment of the present invention;

FIG. 4 is a view showing a coil separator of the deflection yoke shown in FIG. 3;

FIG. 5 is a view taken along a line A-A of FIG. 4;

FIG. 6 is a view taken along a line B-B of FIG. 5;

FIG. 7 is a front view showing another coil separator of the deflection yoke shown in FIG. 3;

FIG. 8 is a view taken along a line C-C of FIG. 7;

FIG. 9 is a side view showing a hook-type protrusion of the coil separator shown in FIG. 7;

FIG. 10 is a view showing the vertical deflection coil and the coil separator shown in FIGS. 3 and 7, respectively, before being assembled;

FIG. 11 is a front view showing an assembly state of the vertical deflection coil and the coil separator shown in FIGS. 3 and 7, respectively;

FIG. 12 is a view showing a ferrite core;

FIG. 13 is a front view showing an assembly state of the coil separator and the ferrite core shown in FIGS. 7 and 12, respectively; and

FIG. 14 is a side view showing the assembly state of the coil separator and the ferrite core shown in FIGS. 7 and 12, respectively.

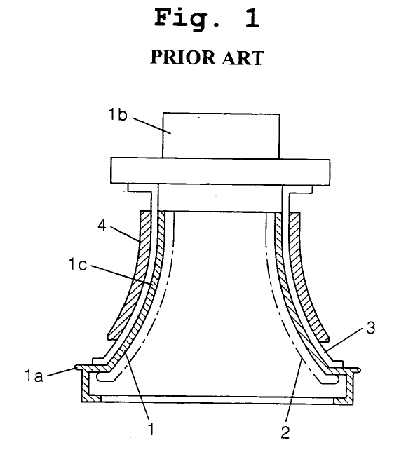

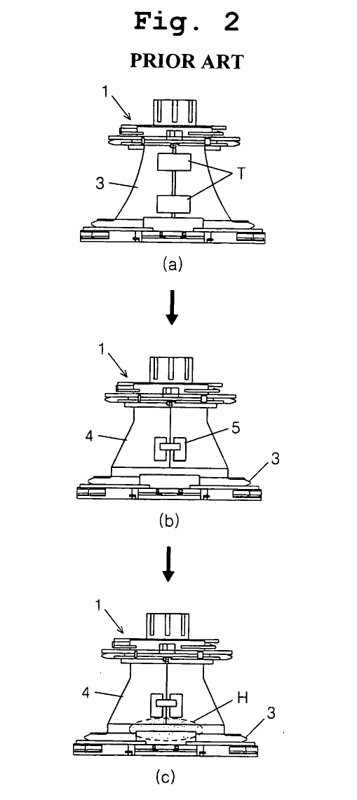

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by reference to the figures.

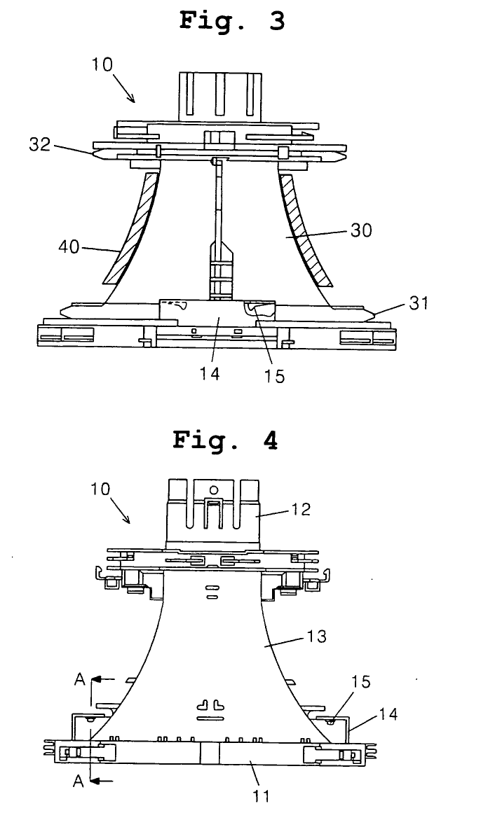

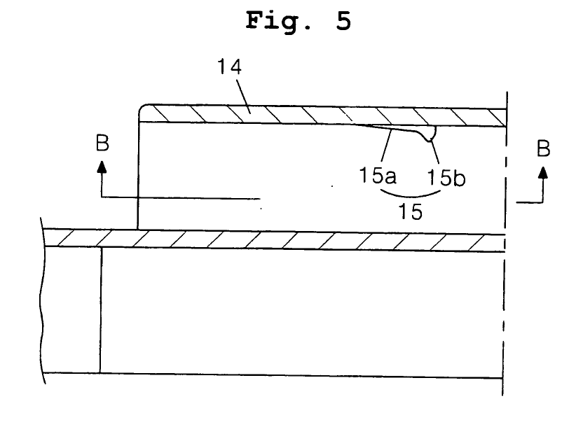

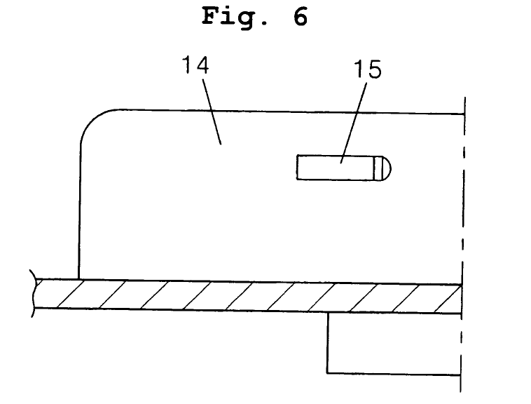

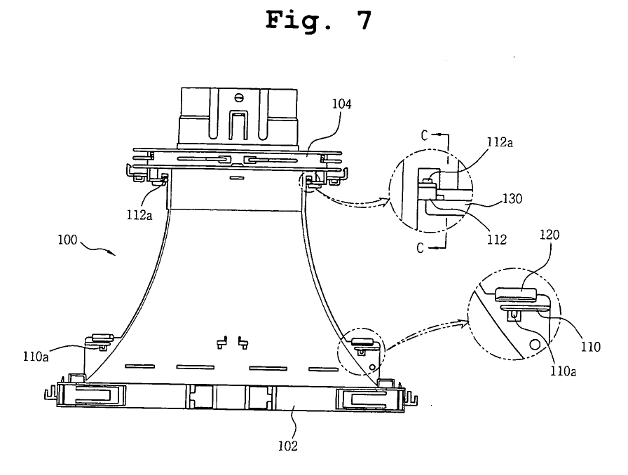

FIG. 3 is a view showing a vertical deflection coil fixing structure of a deflection yoke according to an embodiment of the present invention, FIG. 4 is a view showing a coil separator of the deflection yoke shown in FIG. 3, FIG. 5 is a view taken along a line A-A of FIG. 4, and FIG. 6 is a view taken along a line B-B of FIG. 5.

Referring to FIG. 3, the deflection yoke includes a coil separator 10, a horizontal deflection coil (not shown) and a vertical deflection coil 30 disposed on an inside and an outside of the coil separator 10 to deflect an electron beam emitted from an electron gun in horizontal and vertical directions, respectively, and a ferrite core 40 covering the vertical deflection coil 30.

As shown in FIG. 4, the coil separator 10 includes a screen portion 11 having a first diameter and formed on a first end of the coil separator 10, a neck portion 12 having a second diameter smaller than the first diameter and formed on a second end of the coil separator, and a connection portion 13 having a trumpet shape and connecting the screen portion 11 and the neck portion 12 to form an integrated body.

The vertical deflection coil 30 having a saddle shape is disposed on a circumference of the connection portion 13 of the coil separator 10 to be assembled with the coil separator 10.

The vertical deflection coil 30 has the same saddle shape as the coil separator 10 and includes a pair of vertical deflection sub-coils each having a screen bent portion 31 corresponding to a screen portion 11 of the coil separator 10 and a neck bent portion 32 corresponding to a neck portion 12 of the coil separator 10. The vertical deflection sub-coils of the vertical deflection coil 30 face each other in opposite directions to be closely attached to the connection portion 13 of the coil separator 10.

Here, a support portion 14 having a cross-section of “ [symbol] ” protrudes from the screen portion 11 of the coil separator 10 to support a portion of the screen bent portion 31 of the vertical deflection coil 30, and a hook-type protrusion 15 is formed on the support 14 to be coupled to the screen bent portion 31 of the vertical deflection coil 30 when the vertical deflection coil 30 is assembled with the coil separator 10, thereby fixing the vertical deflection coil 30 to the coil separator 10.

The support portion 14 includes a plurality of sub-supports disposed on opposite sides of the screen portion 11 of the coil separator 10, and the hook-type protrusion 15 includes a plurality of sub-protrusions protruding toward the screen portion 11 of the coil separator 10.

The vertical deflection coil 30 having the saddle type includes a plurality of pin sections formed on the screen bent portion 31 and the neck bent portion 32.

Here, the screen bent portion 31 of the vertical deflection coil 30 is formed with a pin hole (not shown) through which the hook-type protrusion 15 of the coil separator 10 is inserted into the vertical deflection coil 30. The vertical deflection coil 30 is fixed on the coil separator 10 by inserting the hook-type protrusion 15 of the coil separator 10 into the pin section of the vertical deflection coil 30 through the pin hole.

Here, the hook-type protrusion 15 of the coil separator 10 includes an inclined surface 15a inclined inward with respect to a direction in which the vertical deflection coil 30 is inserted into the coil separator 10, and a hook surface 15 preventing the vertical deflection coil 30 from being released from the coil separator 10 when the screen bent portion 31 of the vertical deflection coil 30 is completely inserted between the support portion 14 and the screen portion of the coil separator 10 as shown in FIG. 5.

As described above, the hook-type protrusion 15 is formed on the screen portion 11 of the coil separator 10 as an example. However, the present invention is not limited thereto. That is, the hook-type protrusion 15 may be formed on the neck portion 12 of the coil separator 10 to be coupled to the neck bent portion 32 of the vertical deflection coil 30.

An assembling operation of the deflection yoke having the above structure according to the present invention will be explained hereinafter.

When the vertical deflection coil 30 is assembled into the coil separator 10, the screen vent portion 31 of the vertical deflection coil 30 is inserted into the support 14 of the coil separator 10, and the hook-type sub-protrusions 15 formed on the both sides of the coil separator 10 is coupled to the vertical deflection coil 30 through the pin holes of the vertical deflection coil 30.

Accordingly, the screen bent portion 31 of the vertical deflection coil 30 is fixed on the screen portion 11 of the coil separator 10, and the deflection coil 30 can be firmly secured at its both sides.

When the vertical deflection sub-coils of the vertical deflection coil 30 are fixed on both sides of the coil separator 10 using the hook-type protrusions 15, the ferrite core 40 is attached to cover the vertical deflection coil 30 using a coupling member (not shown), thereby finishing an assembling process of the vertical deflection coil 30.

Compared to a conventional assembling process of a conventional vertical deflection coil and a conventional coil separator, the assembling process according to the present invention can eliminate the conventional assembling process including a tape attaching process of attaching a tape to the conventional vertical deflection coil and the conventional coil separator and a hot melt applying process of applying a hot melt material to the conventional vertical deflection coil, thereby improving an assembling efficiency of the vertical deflection coil 30.

Since the tape attaching process and the hot melt applying process are removed from the assembling process of the present invention, a material cost is reduced. Since a manufacturing efficiency is improved since the number of manufacturing processes is reduced during the assembling process of the present invention.

Since the ferrite core 40 is attached to cover the vertical deflection coil 30 using the coupling member (not shown) using the hook-type protrusion when the vertical deflection sub-coils of the vertical deflection coil 30 are fixed on the both sides of the coil separator 10 using the hook-type protrusion 15, the vertical deflection coil 30 is prevented from being minutely moved during assembling the vertical deflection coil 30, and an assembling state of the vertical deflection coil 30 with respect to the coil separator 10 is maintained stable, thereby reducing a picture dispersion of a TV image on a CRT.

Since the hot melt applying process is removed, a bad smell generating during a conventional attaching process of the conventional vertical deflection coil to the conventional coil separator is prevented, and a working environment is improved.

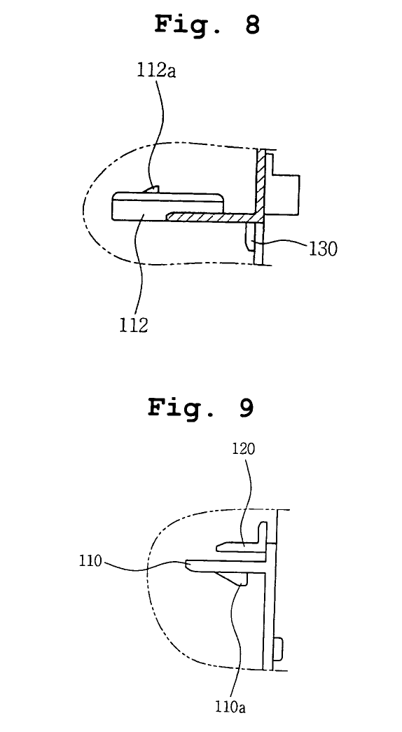

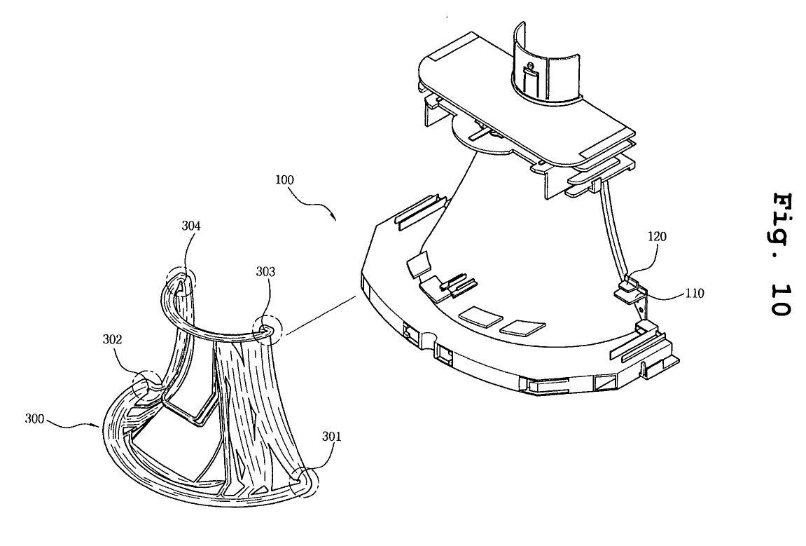

FIG. 7 is a front view showing another coil separator 100 of the deflection yoke shown in FIG. 3, FIG. 8 is a view taken along a line C-C of FIG. 7, FIG. 9 is a side view showing a hook-type protrusion 110a of the another coil separator 100 shown in FIG. 7, and FIG. 10 is a view showing a vertical deflection coil 300 and the another coil separator 100 shown in FIGS. 3 and 7, respectively, before being assembled.

The coil separator 100 includes a screen portion 102, a neck portion 104, and a plurality of hook type protrusions 110a, 112a formed on the screen portion 102 and the neck portion 104, respectively, to couple the vertical deflection coil 300 to the coil separator 100.

Although FIG. 4 shows the hook type protrusion 11 formed on the screen portion 11 of the coil separator 100, FIG. 7 shows the hook type protrusions 110a, 112a formed on the screen portion 102 and the neck portion 104 of the coil separator 100, respectively.

The hook type protrusions 110a are symmetrically formed on both sides (left and right sides) of the screen portion 102 of the soil separator 100, and the hook type protrusions 112a are also symmetrically formed on bother sides (left and right sides) of the neck portion 104 of the coil separator 100. Two pairs of the hook type protrusions 110a, 112a are symmetrically disposed on both sides of the coil separator 100 with respect to a longitudinal axis of the deflection yoke.

The hook type protrusions 110a, 112a are coupled to the vertical deflection coil 300 through pin holes 301, 302, 303, 304 formed on a screen bent portion and a neck bent portion of the vertical deflection coil 300, respectively, to couple the vertical deflection coil 300 to the coil separator 100.

Accordingly, the pin holes 301, 302, 303, 304 are formed on the screen bent portion and the neck bent portion of the vertical deflection coil 300 to correspond to the hook type protrusions 110a, 112a, respectively.

The hook type protrusions 110a, 112a are integrally formed with supports 110, 112 formed on the screen portion 102 and the neck portion 104 of the coil separator 100, respectively.

That is, the supports 110, 112 are formed on the both sides of the screen portion 102 and the neck portion 104 of the coil separator 100, and the hook type protrusions 110a, 112a are formed on corresponding ones of the supports 110, 112.

The supports 110, 112 are formed of a thin plate having at least one end coupled to the coil separator 100 and extending from the at least one end in an axial direction (longitudinal direction) of the screen portion 102 and the neck portion 104 of the coil separator 100 and in perpendicular (circular) directions to the axial direction of the screen portion 102 and the neck portion 104 of the coil separator 100, respectively.

Since the coil separator 100 is formed on plastic injection molding, the supports 110, 112 have an elastic force with respect to the at least one end of the thin plate coupled to the coil separator 100.

Here, the hook type protrusions 110a is formed on the support 102 of the screen portion 102 of the coil separator 100 to protrude toward the screen portion 102, that is, as shown in FIG, the hook type protrusions 110a protrude from the support 102 toward the screen portion 102 of the coil separator 100 when the coil separator 100 is disposed to have the screen portion 102 shown at a lower portion of FIG. 7.

The hook type protrusions 112a is formed on the support 112 of the neck portion 104 of the coil separator 100 to protrude toward the neck portion 104, that is, as shown in FIG. 7, the hook type protrusions 112a protrude from the support 112 toward the neck portion 102 of the coil separator 100 when the coil separator 100 is disposed to have the screen portion 102 shown at the lower portion of FIG. 7.

Since the hook type protrusions 112a formed on the neck portion 104 of the coil separator 100 protrude upward to face the neck portion 104, and the at least one end of the support 112 is coupled to the coil separator 100 to elastically move upward and downward with respect to a point where the support 112 and the coil separator 100 are connected, the hook type protrusions 112a of the coil separator 100 are easily inserted into the pin holes 303, 304 formed on the neck bent portion of the vertical deflection coil 300. The vertical deflection coil 300 is firmly secured to the coil separator 100 once the hook type protrusions 112a are coupled to the neck bent portion of the vertical deflection coil 300 through the poi holes 303, 304.

Since the hook type protrusions 110a formed on the screen portion 104 of the coil separator 100 protrude downward to face the screen portion 104, and the at least one end of the support 110 is coupled to the coil separator 100 to elastically move upward and downward with respect to another point where the support 110 and the coil separator 100 are connected, the hook type protrusions 112a of the coil separator 100 are easily inserted into the pin holes 301, 302 formed on the screen bent portion of the vertical deflection coil 300. The vertical deflection coil 300 is firmly secured to the coil separator 100 once the hook type protrusions 110a are coupled to the screen bent portion of the vertical deflection coil 300 through the pin holes 301, 302.

According to the another coil separator 100 shown in FIG. 7, the hook type protrusions 110a, 112a formed on the screen portion and the neck portion of the coil separator 100, respectively, are inserted into corresponding ones of the pin holes 301, 302, 303, 304 to attach the vertical deflection coil 300 to the coil separator 100, thereby easily assembling the vertical deflection coil 300 with the coil separator 100 and improving the assembling process performed by a user.

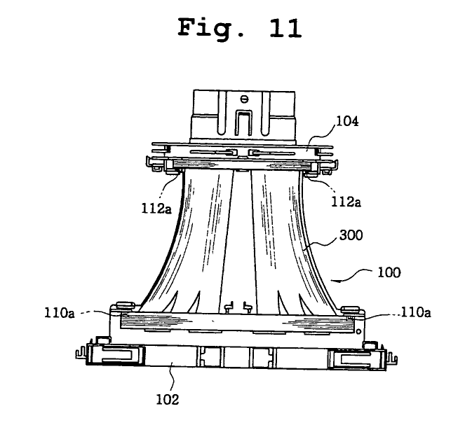

FIG. 11 is a front view showing an assembly state of the vertical deflection coil 300(30) and the coil separator 100 shown in FIGS. 3 and 7, respectively. Referring to FIG. 11, positions of the hook type protrusions 110a, 112a of the coil separator 100 correspond to respectively ones of the pin holes 301, 302, 303, 304 of the vertical deflection coil 300. Therefore, when the hook type protrusions 110a, 112a of the coil separator 100 are inserted into corresponding ones of the pin holes 301, 302, 303, 304 of the vertical deflection coil 300, the vertical deflection 300 is precisely assembled with the coil separator 100.

In order to obtain an assembling reliability of the vertical deflection coil 300 and the coil separator 100, assembling projections 120, 130 are formed on upper and lower portions of dividing surfaces of the coil separator 100 to correspond to assembling grooves 202, 204 formed on upper and lower portion of dividing surfaces of a ferrite core 400.

In a state that the vertical deflection coil 300 is assembled with the coil separator 100 by inserting the hook type protrusions 110a, 112a into the corresponding ones of the pin holes 301, 302, 303, 304, strength of the coil separator 100 may be weakened to cause deformation of the coil separator 100 when an external force or shock is exerted on the coil separator 100 and the vertical deflection coil 300 or an ambient temperature of the coil separator 100 and the vertical deflection coil 300 is increased. Since the vertical deflection coil 300 is deviated from an original (desired) position by a force exerted on the vertical deflection coil 300 in left and right directions with respect to the coil separator 100, it is difficult to obtain a reliable assembling precision of the vertical deflection coil 300 with respect to the coil separator 100.

According to an aspect of the present invention, in order to solve the above and/or other problems and obtain an additional assembling reliability of the vertical deflection coil 300 and the coil separator 100, the assembling projections 120, 130 are formed on the coil separator 100 for assembling the ferrite core 200 with the coil separator 100.

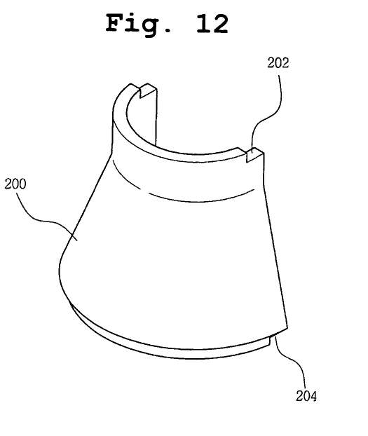

FIG. 12 is a view showing the ferrite core 200. Referring to FIG. 12, the assembling grooves 202, 204 are formed on the upper and lower portions of the dividing surface of the ferrite core 200 to correspond to the assembling projections 120, 130 of the coil separator 100, thereby obtaining the assembling reliability of the deflection yoke.

When the assembling projections 120, 130 are inserted into the assembling grooves 202, 204 of the ferrite core 200, the assembling projections 120, 130 prevent the ferrite core 200 from moving with respect to the vertical deflection coil 300 and the coil separator 100, thereby securing and maintaining the assembling state of the vertical deflection coil 300 and the coil separator 100.

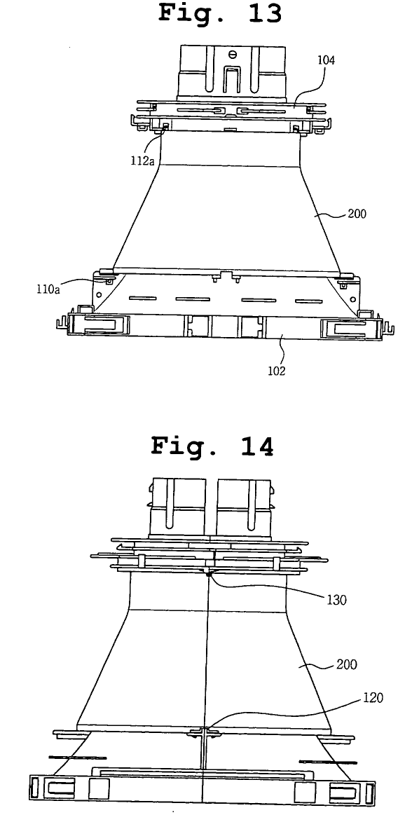

FIG. 13 is a front view showing the assembly state of the coil separator 100 and the ferrite core 200 shown in FIGS. 7 and 12, respectively, and FIG. 14 is a side view showing the assembly state of the coil separator 100 and the ferrite core 200. Referring to FIGS. 13 and 14, after the vertical deflection coil 300 is assembled with the coil separator 100, the ferrite core 200 is fixed on the vertical deflection coil 300. Since the assembling projections 120, 130 are inserted into the assembling grooves 102, 204 of the ferrite core 200 to fix the ferrite core 200 with respect to the vertical deflection coil 300 and the coil separator 100, the ferrite core 200 is stably assembled with the coil separator 100 and prevented from being moved with respect to the vertical deflection coil 300 and the coil separator 100 so as to obtain the assembling reliability.

The assembling process of the coil separator 100, the vertical deflection coil 300, and the ferrite core 200 will be explained with reference to the drawings hereinafter.

When the vertical deflection coil 300 is assembled with the coil separator 100, the screen bent portion and the neck bent portion of the vertical deflection coil 300 are inserted into the supports 110, 112 of the coil separator 100, respectively, (that is, between each of the supports 110, 112 and a corresponding one of the screen portion 102 and the neck portion 104 of the coil separator 100), and the hook type protrusions 110a, 112a are inserted into the vertical deflection coil 300 through the pin holes 301, 302, 303, 304, thereby firmly securing the position of the vertical deflection coil 300 with respect to the coil separator 100.

In a state that the vertical deflection sub-coils of the vertical deflection coil 300 are attached to both sides of the coil separator 100, a pair of sub-cores of the ferrite core 200 are disposed to cover the vertical deflection coil 300. Here, after the assembling projections 120, 130 are inserted into the corresponding ones of the assembling grooves 202, 204 formed on the upper and lower portions of the dividing surfaces of the ferrite core 200, the sub-cores of the ferrite core 200 are clamped using a core clamp (not shown) to adjust positions of the sub-cores of the ferrite core 200 and the vertical deflection sub-coils of the vertical deflection coil 300.

The assembling projections 120, 130 are formed on the coil separator 100 to be inserted into the assembling grooves 202, 204 so that the assembling state of the ferrite core 200 and the vertical deflection core 300 with the coil separator 100 is firmly maintained if any physical force is exerted on the coil separator 100, and the coil separator 100 deteriorates after the vertical deflection coil 300 is assembled with the coil separator 100. Since an assembling structure of [symbol] shapes are formed between the coil separator 100 and the ferrite core 200, a coupling force of the core clamp of the ferrite core 200 is strengthened, and the assembling reliability of the vertical deflection coil 300 and the coil separator 100 is also improved.

Since the ferrite core 200 is stably secured to the vertical deflection coil 300 and the coil separator 100, the vertical deflection coil 300 is precisely assembled.

As described above, since the assembling process of the deflection yoke according to the present invention does not perform the tape attaching process and the hot melt applying process, the assembling efficiency of the vertical deflection coil 300 is improved.

Since the tape attaching process and the hot melt applying process are removed, a manufacturing cost is reduced, and a manufacturing efficiency is improved during assembling the vertical deflection coil 300 with the coil separator 100.

Since the assembling process is easily performed, the vertical deflection coil 300 is securely precisely fixed to the coil separator 100 regardless of skillfulness of the user.

Also, the vertical deflection coil 300 is prevented from minutely moving with respect to the coil separator 100 during assembling the vertical deflection coil 300, and the picture dispersion of the TV image is reduced.

Also, a working environment is improved since the bad smell generating during the hot melt applying process.

An assembled structure of the vertical deflection coil to form the deflection yoke is described as an example. However, the present invention is not limited thereto.

As described above, since the deflection yoke according to the present invention includes the coil separator having the hook type protrusions fixing both sides of the vertical deflection coil, the tape attaching process and the hot melt applying process can be removed, and the assembling efficiency is improved.

The manufacturing cost is reduced since the hot melt applying process is removed, and the working environment is improved since the bad smell is not generated from the hot melt applying process.

The vertical deflection coil 300 is securely precisely fixed to the coil separator 100 regardless of skillfulness of the user since the assembling process is easily performed.

A product performance is improved since the assembling state of the vertical deflection coil is firmly maintained without minutely moving with respect to the coil separator.

Although a few preferred embodiments of the present invention have been shown and described, it would be appreciated by those skilled in the art that changes may be made in this embodiment without departing from the principle and sprit of the invention, the scope of which is defined in the claims and their equivalent.

What is claimed:

1. A deflection yoke comprising:
a coil separator having a screen portion, a neck portion, and a connection portion coupled between the screen portion and the neck portion, and having at least one protrusion formed on at least one of the screen portion and the neck portion;
a horizontal deflection coil disposed on an inside of the coil separator to generate a horizontal magnetic field;
a vertical deflection coil disposed on an outside of the coil separator to generate a vertical magnetic field, and having a pin hole formed on a position corresponding to the at least one protrusion inserted into the pin hole to couple the vertical deflection coil to the coil separator; and
a ferrite core disposed on the vertical deflection coil to strengthen the vertical magnetic field.

2. The deflection yoke of claim 1, wherein the vertical deflection coil comprises a screen bent portion, the coil separator comprises a support formed on the screen portion to support the screen bent portion, and the at least one protrusion of the coil separator is coupled to an upper portion of the screen bent portion of the vertical deflection coil so as to attach the vertical deflection coil to the coil separator.

3. The deflection yoke of claim 1, wherein the at least one protrusion comprises:
an inclined surface inclined with respect to a direction in which the vertical deflection coil is mounted on the coil separator; and
a coupling surface preventing the vertical deflection coil from being released from the at least one protrusion.

4. The deflection yoke of claim 1, wherein the at least one protrusion comprises first and second sub-protrusions formed on the screen portion and the neck portion of the coil separator, respectively, and the at least one pin hole comprises first and second sub-pin holes formed on the coil separator at positions corresponding to the first and second sub-protrusions.

5. The deflection yoke of claim 4, wherein the coil separator comprises first and second supports formed on the screen portion and the neck portion of the coil separator, respectively, and the first and second sub-protrusions are formed on a lower surface of the first support and an upper surface of the second support, respectively.

6. The deflection yoke of claim 5, wherein the coil separator comprises an assembling projection, and the ferrite core comprises an assembling groove corresponding to the assembling projection.

7. A deflection yoke comprising:
a coil separator having a screen portion, a neck portion, and a connection portion formed between the screen portion and the neck portion, and having at least one support having a protrusion; and
a vertical deflection coil disposed on the coil separator to generate a vertical magnetic field, and having at least one pin hole which is formed on a position corresponding to the at least one protrusion and through which the protrusion of the coil separator is coupled to the vertical deflection coil.

8. The deflection yoke of claim 7, wherein:
the pin hole comprises,
a plurality of pin sub-holes;
the vertical deflection coil comprises,
a plurality of vertical deflection sub-coils each having the pin sub-holes; and
the protrusion comprises,
a plurality of sub-protrusions corresponding to respective ones of the pin sub-holes.

9. The deflection yoke of claim 8, wherein the pin sub-holes are disposed at corresponding ones of end portions of each of the vertical deflection sub-coils.

10. The deflection yoke of claim 8, wherein the sub-protrusions are inserted into corresponding ones of the pin sub-holes when the vertical deflection sub-coils are attached to the coil separator.

11. The deflection yoke of claim 7, wherein the support comprises a first portion coupled to the coil separator, a second portion extended from the first portion in an radial direction of the coil separator, and a third portion extended from the second portion in a circular direction of the coil separator.

12. The deflection yoke of claim 11, wherein the at least one protrusion is formed on the third portion of the support to face one of the screen portion and the neck portion.

13. The deflection yoke of claim 11, wherein the third portion is a free end.

14. The deflection yoke of claim 11, wherein the vertical deflection coil comprises:
a portion disposed between the third portion of the support and the coil separator.

15. The deflection yoke of claim 14, wherein the protrusion is inserted into the pin hole when the portion of the vertical deflection coil is inserted between the third portion of the support and the coil separator.

16. The deflection yoke of claim 7, further compring:
a ferrite coil having a plurality of ferrite sub-coils each having assembling grooves, wherein the coil separator comprise a plurality of assembling projections corresponding to respective assembling grooves, and the assembling projections are extended in a radial direction of the coil separator.

17. The deflection yoke of claim 7, wherein the protrusion comprises:
an inclined surface inclined with respect to a direction in which the vertical deflection coil is disposed to be coupled to the coil separator; and
a hook surface on which the protrusion is disposed when the vertical deflection coil is completely coupled to the coil separator so as to firmly couple the vertical deflection coil to the coil separator.

18. The deflection yoke of claim 7, further compring:
a ferrite coil having a plurality of ferrite sub-coils each having assembling grooves, wherein the coil separator comprises a plurality of assembling projections corresponding to respective assembling grooves.

19. The deflection yoke of claim 18, wherein the assembling projections are disposed in corresponding ones of the assembling grooves when the ferrite sub-coils are attached to the vertical deflection coil.

20. A deflection yoke comprising:
a coil separator having a screen portion, a neck portion, and a connection portion, having first supports formed on the screen portion and first protrusions, and having secodn supports formed on the neck portion and second protrusions; and
a plurality of vertical deflection sub-coils disposed on an outside of the coil separator to generate a vertical magnetic field, having a screen bent portion and a neck bent portion, and having first pin holes formed on the screen bent portion to receive corresponding ones of the first protrusions of the coil separators, and second pin holes formed on the neck bent portion to receive corresponding ones of the second protrusions.

21. The deflection yoke of claim 20, further comprising:
a ferrite core covering the vertical deflection coil and having a plurality of assembling grooves, wherein the coil separator comprises:
a plurality of assembling projections inserted into corresponding ones of the assembling grooves when the ferrite core is completely attached to the vertical deflection coil.

22. A display device having a deflection yoke, comprising:
a coil separator having a screen portion, a neck portion, and a connection portion formed between the screen portion and the neck portion, having first supports formed on the screen portion and first protrusions, and having second supports formed on the neck portion and second protrusions; and
a plurality of vertical deflection sub-coils disposed on an outside of the coil separator to generate a vertical magnetic field, having a screen bent portion and a neck bent portion, and having first pin holes formed on the screen bent portion to receive corresponding ones of the first protrusions of the coil separators, and second pin holes formed on the neck bent portion to receive corresponding ones of the second protrusions.
